(19) United States
(12) Patent Application Publication
(10) Pub. No.: US 2024/0417559 A1
(43) Pub. Date: Dec. 19, 2024

(54) CURABLE COMPOSITION

(71) Applicant: KANEKA CORPORATION, Osaka (JP)

(72) Inventor: Dong Zhang, Hyogo (JP)

(73) Assignee: KANEKA CORPORATION, Osaka (JP)

(21) Appl. No.: 18/819,631

(22) Filed: Aug. 29, 2024

Related U.S. Application Data
(63) Continuation of application No. PCT/JP2023/005683, filed on Feb. 17, 2023.

(30) Foreign Application Priority Data
Mar. 1, 2022 (JP) 2022-030600
Jun. 2, 2022 (JP) 2022-090108

(51) Int. Cl. C08L 51/00; C08G 77/44; C08K 5/31; C08K 5/544; C08L 71/08; C09J 151/00; C09J 171/08

(52) U.S. Cl. CPC C08L 51/003; C08G 77/44; C08K 5/31; C08K 5/544; C08L 71/08; C09J 151/003; C09J 171/08; C08G 2170/00; C08L 2205/03

(57) ABSTRACT

A curable composition that contains a hydrolyzable silyl group-containing polymer and that exhibits improved adhesion to polyolefinic materials is provided. The curable composition contains (A) a hydrolyzable silyl group-containing (meth)acrylic ester polymer, (B) a chlorinated polyolefin resin, and (C) a nitrogen-containing dialkoxysilane compound. The curable composition may further contain a guanidino group-containing compound (D) or a hydrolyzable silyl group-containing polyoxyalkylene polymer (E).

### TECHNICAL FIELD

One or more embodiments of the present invention relate to a curable composition containing a polymer having a hydrolyzable silyl group.

### BACKGROUND

Polymers having hydrolyzable silyl groups are known as moisture-reactive polymers. Curable compositions containing such polymers are used as many kinds of industrial products such as adhesives, sealing materials, coating materials, paints, and pressure-sensitive adhesives in diverse fields. Polymer backbones known as those of the polymers having hydrolyzable silyl groups include various polymers such as polyoxyalkylene polymers, saturated hydrocarbon polymers, and (meth)acrylic ester copolymers.

It is known that an adherend made of a polyolefinic material is difficult to bond to another material even when an adhesive is applied to the adherend.

Patent Literature 1 aims to improve adhesion to such a polyolefinic adherend and describes an adhesive composition containing: a (meth)acrylic ester copolymer having a hydrolyzable silyl group and a given monomer composition; a polyoxyalkylene polymer having a hydrolyzable silyl group; and a chlorinated polyolefin resin.

### PATENT LITERATURE

PTL 1: Japanese Laid-Open Patent Application Publication No. 2007-269935

Although the adhesive composition described in Patent Literature 1 exhibits somewhat improved adhesion to a polyolefinic adherend, the adhesion achieved has been found to be insufficient. In particular, it has been demonstrated that the adhesion tends to be significantly low if there is a certain time lag between when the adhesive composition is prepared and when the composition is applied to the adherend to bond the adherend to another material.

### SUMMARY

In view of the above circumstances, one or more embodiments of the present invention aim to provide a curable composition that contains a hydrolyzable silyl group-containing polymer and that exhibits improved adhesion to polyolefinic materials.

As a result of intensive studies, the present inventors have found that blending a hydrolyzable silyl group-containing (meth)acrylic ester polymer with a chlorinated polyolefin resin and a nitrogen-containing dialkoxysilane compound results in improved adhesion to polyolefinic materials. This finding has led the inventors to one or more embodiments of the present invention.

Specifically, one or more embodiments of the present invention relate to a curable composition containing:
(A) a hydrolyzable silyl group-containing (meth)acrylic ester polymer having a hydrolyzable silyl group;
(B) a chlorinated polyolefin resin; and
(C) a nitrogen-containing dialkoxysilane compound.

Preferably, the hydrolyzable silyl group is represented by the following formula (1):

—Si(R¹)₃₋ₐ(X)ₐ (1), wherein

R¹ groups are each independently a hydrocarbon group having 1 to 20 carbon atoms, the hydrocarbon group optionally has a heteroatom-containing group, X groups are each independently a hydroxy group or a hydrolyzable group, and a is 1, 2, or 3.

One or more embodiments of the present invention also relate to a cured product of the curable composition.

One or more embodiments of the present invention further relate to a laminate structure including two adherends joined to each other by an adhesive layer formed by curing of the curable composition, wherein at least one of the two adherends is formed from a polyolefinic material.

One or more embodiments of the present invention can provide a curable composition that contains a hydrolyzable silyl group-containing polymer and that exhibits improved adhesion to polyolefinic materials.

In particular, the curable composition can achieve high adhesion to a polyolefinic material even if there is a certain time lag between when the curable composition is prepared and when the composition is used to bond the polyolefinic material to another material.

In addition, a curable composition according to a preferred aspect has not only high adhesion to polyolefinic materials but also high storage stability and is resistant to increase in viscosity over time during storage.

### DETAILED DESCRIPTION OF THE EMBODIMENTS

Hereinafter, one or more embodiments of the present invention will be specifically described. One or more embodiments of the present invention are not limited to the embodiment described below.

A curable composition according to one or more embodiments contains: (A) a hydrolyzable silyl group-containing (meth)acrylic ester polymer having a hydrolyzable silyl group; (B) a chlorinated polyolefin resin; and (C) a nitrogen-containing dialkoxysilane compound.

### <<Hydrolyzable Silyl Group-Containing (Meth)Acrylic Ester Polymer (A)>>

The curable composition according to one or more embodiments contains a hydrolyzable silyl group-containing (meth)acrylic ester polymer (A) as an essential component.

The (meth)acrylic ester polymer (A) has a hydrolyzable silyl group. The term “hydrolyzable silyl group” refers to a silicon group having a hydroxy or hydrolyzable group on a silicon atom and able to form a siloxane bond through a hydrolysis-condensation reaction.

Specifically, the hydrolyzable silyl group of the (meth)acrylic ester polymer (A) can be represented by the following formula (1).

—Si(R¹)₃ₐ(X)ₐ (1)

R¹ groups are each independently a hydrocarbon group having 1 to 20 carbon atoms, and the hydrocarbon group optionally has a heteroatom-containing group. The number of carbon atoms may be from 1 to 10, from 1 to 8, from 1 to 6, from 1 to 3, or 1 or 2.

The term “heteroatom-containing group” refers to a group containing a heteroatom. Any atom other than carbon and hydrogen atoms is referred to as a “heteroatom”. Suitable examples of the heteroatom include N, O, S, P, Si, and halogen atoms.

Examples of R¹ include: alkyl groups such as methyl, ethyl, n-propyl, isopropyl, n-butyl, tert-butyl, n-hexyl, 2-ethylhexyl, and n-dodecyl groups; unsaturated hydrocarbon groups such as vinyl, isopropenyl, and allyl groups; cycloalkyl groups such as a cyclohexyl group; aryl groups such as phenyl, toluyl, and 1-naphthyl groups; and aralkyl groups such as a benzyl group. R¹ may be an alkyl group or an aryl group, a methyl group, an ethyl group, or a phenyl group, a methyl group or an ethyl group, or a methyl group. Only one type of group or two or more types of groups may be used as the R¹ groups.

X groups are each independently a hydroxy group or a hydrolyzable group. Examples of X include a hydroxy group, hydrogen, halogens, and alkoxy, acyloxy, ketoximate, amino, amide, acid amide, aminooxy, mercapto, and alkenyloxy groups. The alkoxy and other groups may be substituted with a substituent. The alkoxy groups are preferred in terms of moderate hydrolyzability and ease of handling. Methoxy, ethoxy, n-propoxy, and isopropoxy groups are more preferred, methoxy and ethoxy groups are even more preferred, and a methoxy group is particularly preferred. Only one type of group or two or more types of groups may be used as the X groups.

In the formula (1), a is 1, 2, or 3. The integer a may be 2 or 3. In terms of the balance between the curability of the curable composition and the physical properties of a cured product of the composition, a may be 2. To further enhance the curability of the composition and the recovery performance of the cured product, a may be 3.

Examples of the hydrolyzable silyl group of the (meth)acrylic ester polymer (A) include trimethoxysilyl, triethoxysilyl, tris(2-propenyloxy) silyl, triacetoxysilyl, methyldimethoxysilyl, methyldiethoxysilyl, ethyldimethoxysilyl, ethyldiethoxysilyl, n-propyldimethoxysilyl, n-hexyldimethoxysilyl, phenyldimethoxysilyl, phenyldiethoxysilyl, methyldiisopropenoxysilyl, methyldiphenoxysilyl, and dimethylmethoxysilyl groups. In terms of ensuring both the storage stability and the curability of the curable composition, a methyldimethoxysilyl group is more preferred. To further enhance the curability of the composition and the recovery performance of the cured product, a trimethoxysilyl group is more preferred.

The hydrolyzable silyl group may be bonded to one or both ends of the main chain of the (meth)acrylic ester polymer (A) or may be bonded as a side chain to a site other than the ends of the main chain. Stating that the hydrolyzable silyl group is bonded as a side chain means that the hydrolyzable silyl group is bonded to a repeating unit that is one of the repeating units forming the main chain and that is other than the two repeating units respectively located at the two ends of the main chain. The hydrolyzable silyl group as a side chain may be bonded directly to the main chain or may be bonded indirectly to the main chain via another molecular chain.

In the case where a polyoxyalkylene polymer (E) described later is not used in the curable composition according to one or more embodiments, it is preferable, in terms of the adhesion to polyolefinic materials, for the (meth)acrylic ester polymer (A) to have the hydrolyzable silyl group at one or both ends of the main chain. In the case where the (meth)acrylic ester polymer (A) and the polyoxyalkylene polymer (E) are used in combination, the (meth)acrylic ester polymer (A) may have the hydrolyzable silyl group at one or both ends of the main chain or in a side chain.

The average number of the hydrolyzable silyl groups per molecule of the (meth)acrylic ester polymer (A) is not limited to a particular range. In terms of the balance between the curing speed of the curable composition and the strength of the resulting cured product, the average number of the hydrolyzable silyl groups per molecule of the (meth)acrylic ester polymer (A) may be from 0.05 to 5.0, from 0.1 to 4.0, or from 0.5 to 3.0.

The (meth)acrylic ester monomer used to form the main chain of the (meth)acrylic ester polymer (A) is not limited to a particular type and can be any (meth)acrylic ester monomer. Specific examples include (meth)acrylic monomers such as methyl (meth)acrylate, ethyl (meth)acrylate, n-propyl (meth)acrylate, isopropyl (meth)acrylate, n-butyl (meth)acrylate, isobutyl (meth)acrylate, tert-butyl (meth)acrylate, n-pentyl (meth)acrylate, n-hexyl (meth)acrylate, cyclohexyl (meth)acrylate, n-heptyl (meth)acrylate, n-octyl (meth)acrylate, 2-ethylhexyl (meth)acrylate, nonyl (meth)acrylate, decyl (meth)acrylate, dodecyl (meth)acrylate, phenyl (meth)acrylate, toluyl (meth)acrylate, benzyl (meth)acrylate, 2-methoxyethyl (meth)acrylate, 3-methoxybutyl (meth)acrylate, 2-hydroxyethyl (meth)acrylate, 2-hydroxypropyl (meth)acrylate, stearyl (meth)acrylate, glycidyl (meth)acrylate, (3-trimethoxysilyl) propyl (meth)acrylate, (3-dimethoxymethylsilyl) propyl (meth)acrylate, (2-trimethoxysilyl)ethyl (meth)acrylate, (2-dimethoxymethylsilyl)ethyl (meth)acrylate, trimethoxysilylmethyl (meth)acrylate, (dimethoxymethylsilyl)methyl (meth)acrylate, an ethylene oxide adduct of (meth)acrylic acid, trifluoromethylmethyl (meth)acrylate, 2-trifluoromethylethyl (meth)acrylate, 2-perfluoroethylethyl (meth)acrylate, 2-perfluoroethyl-2-perfluorobutylethyl (meth)acrylate, perfluoroethyl (meth)acrylate, trifluoromethyl (meth)acrylate, bis(trifluoromethyl)methyl (meth)acrylate, 2-trifluoromethyl-2-perfluoroethylethyl (meth)acrylate, 2-perfluorohexylethyl (meth)acrylate, 2-perfluorodecylethyl (meth)acrylate, and 2-perfluorohexadecylethyl (meth)acrylate.

Examples of monomer units other than those listed above include: carboxy group-containing monomers such as acrylic acid and methacrylic acid; amide group-containing monomers such as N-methylolacrylamide and N-methylolmethacrylamide; epoxy group-containing monomers such as glycidyl acrylate and glycidyl methacrylate; and amino group-containing monomers such as diethylaminoethyl acrylate and diethylaminoethyl methacrylate.

The (meth)acrylic ester polymer (A) used can be a polymer obtained by copolymerization of a (meth)acrylic ester monomer with a vinyl monomer copolymerizable with the (meth)acrylic ester monomer. Examples of the vinyl monomer include, but are not limited to, styrene monomers such as styrene, vinyltoluene, α-methylstyrene, chlorostyrene, styrenesulfonic acid, and salts of styrenesulfonic acid; fluorine-containing vinyl monomers such as perfluoroethylene, perfluoropropylene, and vinylidene fluoride; silicon-containing vinyl monomers such as vinyltrimethoxysilane and vinyltriethoxysilane; maleic anhydride; maleic acid; monoalkyl and dialkyl esters of maleic acid; fumaric acid; monoalkyl and dialkyl esters of fumaric acid; maleimide monomers such as maleimide, methylmaleimide, ethylmaleimide, propylmaleimide, butylmaleimide, hexylmaleimide, octylmaleimide, dodecylmaleimide, stearylmaleimide, phenylmaleimide, and cyclohexylmaleimide; nitrile group-containing vinyl monomers such as acrylonitrile and methacrylonitrile; amide group-containing vinyl monomers such as acrylamide and methacrylamide; vinyl ester monomers such as vinyl acetate, vinyl propionate, vinyl pivalate, vinyl benzoate, and vinyl cinnamate; alkenyl monomers such as ethylene and propylene; conjugated diene monomers such as butadiene and isoprene; vinyl chloride; vinylidene chloride; allyl chloride; and allyl alcohol. Two or more of these vinyl monomers can be used as copolymerization components.

The monomer composition of the (meth)acrylic ester polymer (A) can be chosen depending on the intended use or purpose of the curable composition. In the case where the curable composition is used as an adhesive or any other product which is required to have a certain level of strength, the (meth)acrylic ester polymer (A) may have a relatively high glass transition temperature (Tg). Specifically, the Tg may be from 0 to 200° C. or from 20 to 100° C. The Tg can be determined by the Fox equation given below.

Fox equation:

1/(Tg(K))=Σ(Mi/Tgi), wherein

Mi is the weight fraction of a monomer component i of the polymer and Tgi is the glass transition temperature (K) of a homopolymer of the monomer i.

The number-average molecular weight of the (meth)acrylic ester polymer (A) is not limited to a particular range. The number-average molecular weight as determined by GPC analysis as a polystyrene-equivalent molecular weight may be from 1,000 to 100,000, from 5,000 to 80,000, or from 10,000 to 60,000. When the number-average molecular weight of the (meth)acrylic ester polymer (A) is in the above range, a cured product that exhibits high strength and high elongation is likely to be formed. In addition, a viscosity desired in terms of workability is likely to be achieved.

The (meth)acrylic ester polymer (A) is not limited to having a particular molecular weight distribution (Mw/Mn). The dispersity Mw/Mn may be, for example, 5.0 or less and may be 3.0 or less, 2.0 or less, 1.8 or less, 1.6 or less, or 1.4 or less. The lower limit is not limited to a particular value, but the dispersity Mw/Mn should be 1 or more.

Synthesis of the (meth)acrylic ester polymer (A) is not limited to using a particular method and may be accomplished by any known method. Radical polymerization is preferred in terms of usability of monomers and ease of control of the polymerization reaction.

The radical polymerization can be broadly classified into “free radical polymerization” and “living radical polymerization”. The “free radical polymerization” is a simple polymerization method in which a monomer is polymerized using an azo compound, a peroxide, or any other compound as a polymerization initiator. When conducted using a chain transfer agent having a given functional group, the “free radical polymerization” can yield a polymer having the functional group at one or both ends of the polymer backbone. In the “living radical polymerization”, the growing polymer ends grow under given reaction conditions without undergoing a side reaction such as a termination reaction. The “living radical polymerization” can yield a polymer having a desired molecular weight, a narrow molecular weight distribution, and a low viscosity, and permits structural monomer units derived from a monomer having a given functional group to be introduced substantially at desired sites in the resulting polymer.

The details of these polymerization methods are disclosed in paragraphs to of WO 2012/020560 and paragraphs to of Japanese Laid-Open Patent Application Publication No. 2014-114434.

Examples of other polymerization methods which may be used include: a method as described in Japanese Laid-Open Patent Application Publication No. 2001-040037, in which an acrylic polymer is obtained using a metallocene catalyst and a thiol compound having at least one hydrolyzable silyl group in the molecule; and a high-temperature continuous polymerization method as described in Japanese Laid-Open Patent Application Publication (Translation of PCT Application) No. S57-502171, Japanese Laid-Open Patent Application Publication No. S59-006207, or Japanese Laid-Open Patent Application Publication No. S60-511992, in which continuous polymerization of a vinyl monomer is conducted using a mixing vessel-type reactor.

Introduction of hydrolyzable silyl groups into a (meth)acrylic ester polymer is not limited to using a particular method and can be accomplished, for example, using any of the methods listed below.
(i) A method in which a compound having a polymerizable unsaturated group and a hydrolyzable silyl group is copolymerized with the monomer as described above. With this method, the hydrolyzable silyl groups tend to be randomly introduced as side chains.
(ii) A method in which a (meth)acrylic ester polymer is produced by polymerization using a mercaptosilane compound having a hydrolyzable silyl group as a chain transfer agent. With this method, the hydrolyzable silyl groups can be introduced at the ends of the polymer backbone.
(iii) A method in which a compound having a polymerizable unsaturated group and a reactive functional group (V group) is copolymerized and then the resulting copolymer is reacted with a compound having a hydrolyzable silyl group and a functional group reactive with the V group. Specific examples of the method (iii) include: a method in which 2-hydroxyethyl acrylate is copolymerized and then the resulting copolymer is reacted with an isocyanatosilane having a hydrolyzable silyl group; and a method in which glycidyl acrylate is copolymerized and then the resulting copolymer is reacted with an aminosilane compound having a hydrolyzable silyl group.
(iv) A method in which terminal functional groups of a (meth)acrylic ester polymer synthesized by living radical polymerization are modified to introduce hydrolyzable silyl groups into the polymer. The living radical polymerization allows easy introduction of functional groups at the ends of the polymer backbone. The hydrolyzable silyl groups can be introduced at the ends of the polymer backbone by modifying the terminal functional groups.

The following describes examples of silicon compounds that can be used to introduce hydrolyzable silyl groups into a (meth)acrylic ester polymer by any of the above methods. Examples of compounds that can be used as the compound having a polymerizable unsaturated group and a hydrolyzable silyl group in the method (i) include 3-(trimethoxysilyl) propyl (meth)acrylate, 3-(dimethoxymethylsilyl) propyl (meth)acrylate, 3-(triethoxysilyl) propyl (meth)acrylate, (trimethoxysilyl)methyl (meth)acrylate, (dimethoxymethylsilyl)methyl (meth)acrylate, (triethoxysilyl)methyl (meth)acrylate, (diethoxymethylsilyl)methyl (meth)acrylate, and 3-((methoxymethyl)dimethoxysilyl) propyl (meth)acrylate. In terms of availability, 3-trimethoxysilylpropyl (meth)acrylate and 3-(dimethoxymethylsilyl) propyl (meth)acrylate are particularly preferred.

Examples of compounds that can be used as the mercaptosilane compound having a hydrolyzable silyl group in the method (ii) include (3-mercaptopropyl)trimethoxysilane, (3-mercaptopropyl)dimethoxymethylsilane, (3-mercaptopropyl)triethoxysilane, (mercaptomethyl)trimethoxysilane, (mercaptomethyl)dimethoxymethylsilane, and (mercaptomethyl)triethoxysilane.

Examples of compounds that can be used as the compound having a hydrolyzable silyl group and a functional group reactive with the V group in the method (iii) include: isocyanatosilane compounds such as (3-isocyanatopropyl)trimethoxysilane, (3-isocyanatopropyl)dimethoxymethylsilane, (3-isocyanatopropyl)triethoxysilane, (isocyanatomethyl)trimethoxysilane, (isocyanatomethyl)triethoxysilane, (isocyanatomethyl)dimethoxymethylsilane, and (isocyanatomethyl) diethoxymethylsilane; epoxysilane compounds such as (3-glycidoxypropyl)trimethoxysilane, (3-glycidoxypropyl)triethoxysilane, (3-glycidoxypropyl)dimethoxymethylsilane, (glycidoxymethyl)trimethoxysilane, (glycidoxymethyl)triethoxysilane, (glycidoxymethyl)dimethoxymethylsilane, and (glycidoxymethyl) diethoxymethylsilane; and aminosilane compounds such as (3-aminopropyl)trimethoxysilane, (3-aminopropyl)triethoxysilane, (3-aminopropyl)dimethoxymethylsilane, (aminomethyl)trimethoxysilane, (aminomethyl)triethoxysilane, (aminomethyl)dimethoxymethylsilane, (N-cyclohexylaminomethyl)triethoxysilane, (N-cyclohexylamino)methyldiethoxymethylsilane, (N-phenylaminomethyl)trimethoxysilane, (N-(2-aminoethyl)aminomethyl)trimethoxysilane, and (N-(2-aminoethyl)-3-aminopropyl)trimethoxysilane.

In the method (iv), any modification reaction can be used. Examples of the modification reaction method include: a method using a compound having a hydrolyzable silyl group and a functional group reactive with the terminal reactive group resulting from polymerization; and a method in which double bonds are introduced at the ends of the polymer backbone using a compound having a double bond and a functional group reactive with the terminal reactive group and subsequently hydrolyzable silyl groups are introduced at the ends of the polymer backbone through a process such as hydrosilylation.

The methods described above may be used in any combination. For example, the combined use of the methods (ii) and (iii) can result in a (meth)acrylic ester polymer having hydrolyzable silyl groups both at the ends of the polymer backbone and in a side chain.

### <<Chlorinated Polyolefin Resin (B)>>

The curable composition according to one or more embodiments contains a chlorinated polyolefin resin (B). The combined use of the component (B) and a component (C) described later can improve the adhesion to polyolefinic materials.

The term “chlorinated polyolefin resin” refers to a resin resulting from chlorination of a polyolefin resin or a modified product of the polyolefin resin.

The chlorine content of the chlorinated polyolefin resin (B) may be 50 wt % or less or 40 wt % or less. When the chlorine content of the chlorinated polyolefin resin is 50 wt % or less, the adhesion to polyolefinic materials is likely to be further improved. The chlorine content of the chlorinated polyolefin resin may be 10 wt % or more or 20 wt % or more. The higher the chlorine content of the chlorinated polyolefin resin, the more likely the chlorinated polyolefin resin is to be well compatible with the component (A).

Examples of the polyolefin resin chlorinated into the chlorinated polyolefin resin (B) include polyethylene, polypropylene, and propylene-α-olefin copolymer. The propylene-α-olefin copolymer is a copolymer obtained by copolymerization of propylene as a primary component with an α-olefin. Examples of the α-olefin include ethylene, 1-butene, 3-methyl-1-butene, 4-methyl-1-pentene, 1-heptene, 3-methyl-1-heptene, 1-octene, and vinyl acetate, among which ethylene and 1-butene are preferred.

A modified chlorinated polyolefin resin is suitable for use as the chlorinated polyolefin resin (B). The modified chlorinated polyolefin resin used can be a known modified chlorinated polyolefin resin. Specific examples include an acrylic-modified chlorinated polyolefin resin, a maleic acid-modified chlorinated polyolefin resin, and a maleic anhydride-modified chlorinated polyolefin resin. Among these, the maleic anhydride-modified chlorinated polyolefin resin is particularly preferred.

Specific examples of the maleic anhydride-modified chlorinated polyolefin resin include maleic anhydride-modified polypropylene, maleic anhydride-modified propylene-ethylene copolymer, maleic anhydride-modified propylene-butene copolymer, and maleic anhydride-modified propylene-ethylene-butene copolymer.

The amount of the chlorinated polyolefin resin (B) may be from 1 to 60 parts by weight per 100 parts by weight of the component (A) or, in the case where the curable composition contains the component (E) described later, per 100 parts by weight of the total amount of the components (A) and (E). When the amount of the chlorinated polyolefin resin (B) is in this range, it is possible to improve the adhesion to polyolefinic materials while ensuring the curability exhibited by the component (A). The amount of the chlorinated polyolefin resin (B) may be from 3 to 50 parts by weight, from 5 to 45 parts by weight, from 10 to 40 parts by weight, or from 15 to 35 parts by weight.

### <<Nitrogen-Containing Dialkoxysilane Compound (C)>>

The curable composition according to one or more embodiments contains a nitrogen-containing dialkoxysilane compound (C). The use of the component (C) can reduce the increase in modulus of a cured product of the composition. The use of the component (C) in combination with the component (B) described above can improve the adhesion to polyolefinic materials.

The nitrogen-containing dialkoxysilane compound (C) may be also called an amino group-containing silane coupling agent. The compound (C) is a compound having both an amino group and a hydrolyzable silyl group and having two alkoxy groups on a silicon atom. Although an amino group-containing silane coupling agent having three alkoxy groups on a silicon atom is also known, the use of such a compound cannot provide a sufficient improving effect on the adhesion to polyolefinic materials.

The alkoxy groups of the nitrogen-containing dialkoxysilane compound (C) may have 1 to 5 carbon atoms. In particular, the alkoxy groups may be methoxy, ethoxy, n-propoxy, or isopropoxy groups, methoxy or ethoxy groups, or methoxy groups.

Specific examples of the nitrogen-containing dialkoxysilane compound (C) include, but are not limited to, γ-aminopropylmethyldimethoxysilane, γ-aminopropylmethyldiethoxysilane, γ-(2-aminoethyl)aminopropylmethyldimethoxysilane, γ-(2-aminoethyl)aminopropylmethyldiethoxysilane, and N-cyclohexylaminomethyldiethoxymethylsilane.

In terms of the improving effect on the adhesion to polyolefinic materials, the nitrogen-containing dialkoxysilane compound (C) may have a primary amino group (—NH₂).

In terms of the adhesion to polyolefinic materials and the mechanical properties of the cured product of the curable composition, the amount of the nitrogen-containing dialkoxysilane compound (C) may be from 0.1 to 20 parts by weight per 100 parts by weight of the component (A) or, in the case where the curable composition contains the component (E) described later, per 100 parts by weight of the total amount of the components (A) and (E). The amount of the nitrogen-containing dialkoxysilane compound (C) may be from 0.5 to 15 parts by weight, from 1 to 12 parts by weight, or from 2 to 10 parts by weight.

### <<Guanidino Group-Containing Compound (D)>>

The curable composition according to one or more embodiments further contains a guanidino group-containing compound (D) having a guanidino group. The inclusion of the component (D) can improve the storage stability of the curable composition and reduce the increase in viscosity over time during storage. In particular, in the case where there is a certain time lag between when the curable composition is prepared and when the composition is used to bond a polyolefinic material to another material, the component (D) can contribute to improved adhesion to the polyolefinic material.

The guanidino group-containing compound (D) generally includes a substance called a guanidine compound or a biguanide compound.

Examples of the guanidine compound include guanidine, dicyandiamide, 1-methylguanidine, 1-ethylguanidine, 1-cyclohexylguanidine, 1-phenylguanidine, 1-(o)-tolyl) guanidine, 1,1-dimethylguanidine, 1,3-dimethylguanidine, 1,2-diphenylguanidine, 1,1,2-trimethylguanidine, 1,2,3-trimethylguanidine, 1,1,3,3-tetramethylguanidine, 1,1,2,3,3-pentamethylguanidine, 2-ethyl-1,1,3,3-tetramethylguanidine, 1,1,3,3-tetramethyl-2-n-propylguanidine, 1,1,3,3-tetramethyl-2-isopropylguanidine, 2-n-butyl-1,1,3,3-tetramethylguanidine, 2-tert-butyl-1,1,3,3-tetramethylguanidine, 1,2,3-tricyclohexylguanidine, 1-benzyl-2,3-dimethylguanidine, 1,5,7-triazabicyclo[4.4.0]dec-5-ene, 7-methyl-1,5,7-triazabicyclo[4.4.0]dec-5-ene, 7-ethyl-1,5,7-triazabicyclo[4.4.0]dec-5-ene, 7-n-propyl-1,5,7-triazabicyclo[4.4.0]dec-5-ene, 7-isopropyl-1,5,7-triazabicyclo[4.4.0]dec-5-ene, 7-n-butyl-1,5,7-triazabicyclo[4.4.0]dec-5-ene, 7-cyclohexyl-1,5,7-triazabicyclo[4.4.0]dec-5-ene, and 7-n-octyl-1,5,7-triazabicyclo[4.4.0]dec-5-ene.

Examples of the biguanide compound include biguanide, 1-methylbiguanide, 1-ethylbiguanide, 1-n-butylbiguanide, 1-(2-ethylhexyl) biguanide, 1-n-octadecylbiguanide, 1,1-dimethylbiguanide, 1,1-diethylbiguanide, 1-cyclohexylbiguanide, 1-allylbiguanide, 1-phenylbiguanide, 1-(o-tolyl) biguanide, 1-morpholinobiguanide, 1-n-butyl-N2-ethylbiguanide, 1,1′-ethylenebisbiguanide, 1,5-ethylenebiguanide, 1-[3-(diethylamino) propyl]biguanide, 1-[3-(dibutylamino) propyl]biguanide, and N′,N″-dihexyl-3,12-diimino-2,4,11,13-tetraazatetradecanediamidine.

The biguanide compound is preferred as the guanidino group-containing compound (D) in terms of the improving effect on the storage stability. In particular, the guanidino group-containing compound (D) may be a biguanide compound having a substituent, a biguanide compound having a benzene ring, or 1-(o-tolyl) biguanide.

In terms of the adhesion to polyolefinic materials and the improving effect on the storage stability, the amount of the guanidino group-containing compound (D) may be from 0.1 to 20 parts by weight per 100 parts by weight of the component (A) or, in the case where the curable composition contains the component (E) described later, per 100 parts by weight of the total amount of the components (A) and (E). The amount of the guanidino group-containing compound (D) may be from 0.5 to 15 parts by weight, from 1 to 12 parts by weight, or from 2 to 10 parts by weight.

### <<Hydrolyzable Silyl Group-Containing Polyoxyalkylene Polymer (E)>>

The curable composition according to one or more embodiments need not but may contain a hydrolyzable silyl group-containing polyoxyalkylene polymer (E). The inclusion of the hydrolyzable silyl group-containing polyoxyalkylene polymer (E) can improve the storage stability of the curable composition and reduce the increase in viscosity over time during storage. In particular, the combined use of the guanidino group-containing compound (D) described above and the hydrolyzable silyl group-containing polyoxyalkylene polymer (E) can provide a marked improving effect on the storage stability.

The polyoxyalkylene polymer (E) has a hydrolyzable silyl group. The hydrolyzable silyl group can be represented by the formula (1) shown above. The hydrolyzable silyl group of the polyoxyalkylene polymer (E) may be the same or different from the hydrolyzable silyl group of the (meth)acrylic ester polymer (A).

For the polyoxyalkylene polymer (E), specific examples of R¹ in the formula (1) include methyl, ethyl, chloromethyl, methoxymethyl, and N,N-diethylaminomethyl groups. R¹ may be a methyl group, an ethyl group, a chloromethyl group, or a methoxymethyl group or a methyl group or a methoxymethyl group.

Specific examples of the hydrolyzable silyl group of the polyoxyalkylene polymer (E) include, but are not limited to, trimethoxysilyl, triethoxysilyl, tris(2-propenyloxy) silyl, triacetoxysilyl, dimethoxymethylsilyl, diethoxymethylsilyl, dimethoxyethylsilyl, (chloromethyl)dimethoxysilyl, (chloromethyl) diethoxysilyl, (methoxymethyl)dimethoxysilyl, (methoxymethyl) diethoxysilyl, (N,N-diethylaminomethyl)dimethoxysilyl, and (N,N-diethylaminomethyl) diethoxysilyl groups. Among these, methyldimethoxysilyl, trimethoxysilyl, triethoxysilyl, (chloromethyl)dimethoxysilyl, (methoxymethyl)dimethoxysilyl, (methoxymethyl) diethoxysilyl, and (N,N-diethylaminomethyl)dimethoxysilyl groups are preferred because these groups exhibit high activity and contribute to obtaining a cured product having good mechanical properties.

The polyoxyalkylene polymer (E) may have one or less hydrolyzable silyl groups on average per terminal moiety or may have more than one hydrolyzable silyl groups on average per terminal moiety. Having more than one hydrolyzable silyl groups on average per terminal moiety means that the polyoxyalkylene polymer (E) includes a polyoxyalkylene polymer molecule having two or more hydrolyzable silyl groups in one terminal moiety.

The polyoxyalkylene polymer (E) may have 1.0 or less hydrolyzable silyl groups on average per terminal moiety. The average number of hydrolyzable silyl groups may be 0.4 or more, 0.5 or more, or 0.6 or more.

The polyoxyalkylene polymer (E) may have a hydrolyzable silyl group in a site other than terminal moieties. However, it is preferable for the polyoxyalkylene polymer (E) to have hydrolyzable silyl groups only in terminal moieties in order to increase the likelihood of obtaining a rubbery cured product that exhibits high elongation and low elastic modulus.

In terms of the strength of the resulting cured product, the average number of hydrolyzable silyl groups per molecule of the polyoxyalkylene polymer (E) may be more than 1.0, 1.2 or more, 1.3 or more, 1.5 or more, or 1.7 or more. The average number may be 2.0 or less or may be more than 2.0. In terms of the elongation of the cured product, the average number may be 6.0 or less, 5.5 or less, or 5.0 or less.

### <Main Chain Structure>

The polyoxyalkylene polymer (E) is not limited to having a particular backbone. Examples of the backbone of the polyoxyalkylene polymer (E) include polyoxyethylene, polyoxypropylene, polyoxybutylene, polyoxytetramethylene, oxyethylene-oxypropylene copolymer, and oxypropylene-oxybutylene copolymer. Among these, polyoxypropylene is preferred.

The number-average molecular weight of the polyoxyalkylene polymer (E) is not limited to a particular range. The number-average molecular weight as determined by GPC analysis as a polystyrene-equivalent molecular weight may be from 1,000 to 100,000, from 5,000 to 80,000, or from 10,000 to 60,000.

The polyoxyalkylene polymer (E) is not limited to having a particular molecular weight distribution (Mw/Mn) but may have a narrow molecular weight distribution. Specifically, the dispersity Mw/Mn may be less than 2.0, 1.6 or less, 1.5 or less, or 1.4 or less. In terms of improving various mechanical properties such as durability and elongation of the cured product, the dispersity Mw/Mn may be 1.2 or less. The molecular weight distribution of the polyoxyalkylene polymer (E) can be determined from the number-average and weight-average molecular weights obtained by GPC analysis.

The main chain structure of the polyoxyalkylene polymer (E) may be linear or branched.

Synthesis of the polyoxyalkylene polymer (E) is not limited to using a particular method. In one example, first, an epoxy compound is polymerized with an initiator having a hydroxy group to obtain a hydroxy-terminated polymer. An alkali metal salt (e.g., sodium methoxide) is allowed to act on the hydroxy groups of the polymer, and then the resulting polymer is reacted with a halogenated hydrocarbon compound having a carbon-carbon unsaturated bond (e.g., allyl chloride) to introduce carbon-carbon unsaturated bonds at the polymer ends. Subsequently, the polymer is reacted with a hydrolyzable silyl group-containing hydrosilane compound (e.g., dimethoxymethylsilane or trimethoxysilane). In this way, the hydrolyzable silyl group-containing polyoxyalkylene polymer (E) can be obtained.

The introduction of hydrolyzable silyl groups into the polymer can be accomplished also by using a hydrolyzable silyl group-containing mercaptosilane instead of the hydrolyzable silyl group-containing hydrosilane compound.

The main chain of the polyoxyalkylene polymer (E) may contain an ester bond or an amide segment represented by the following formula (3):

—NR⁷—C(═O)— (3), wherein

R⁷ is an organic group having 1 to 10 carbon atoms or a hydrogen atom.

A cured product obtained from a curable composition containing the polyoxyalkylene polymer (E) having an ester bond or an amide segment can have high hardness and high strength by virtue of, for example, the action of hydrogen bonds. However, the polyoxyalkylene polymer (E) containing an amide segment or the like could be cleaved due to heat or any other cause. Additionally, the curable composition containing the polyoxyalkylene polymer (E) containing an amide segment or the like tends to have a high viscosity. In view of the above advantages and disadvantages, the polyoxyalkylene polymer (E) used may be a polyoxyalkylene polymer containing an amide segment or the like or a polyoxyalkylene polymer containing no amide segment or the like.

Examples of the amide segment represented by the formula (3) include an amide segment formed by a reaction between an isocyanate group and a hydroxy group, an amide segment formed by a reaction between an amino group and a carbonate, an amide segment formed by a reaction between an isocyanate group and an amino group, and an amide segment formed by a reaction between an isocyanate group and a mercapto group. A segment formed by a reaction between an amide segment containing an active hydrogen atom and an isocyanate group is also classified as the amide segment represented by the formula (3).

One exemplary method for producing the polyoxyalkylene polymer (E) containing an amide segment is a method in which a polyoxyalkylene polymer terminated by an active hydrogen-containing group is reacted with a polyisocyanate compound to synthesize a polymer terminated by an isocyanate group and after or simultaneously with the synthesis, a compound having both a functional group (e.g., a hydroxy, carboxy, mercapto, or primary or secondary amino group) reactive with the isocyanate group and a hydrolyzable silyl group is reacted with the synthesized polymer. Another example is a method in which a polyoxyalkylene polymer terminated by an active hydrogen-containing group is reacted with a hydrolyzable silyl group-containing isocyanate compound.

In the case where the polyoxyalkylene polymer (E) contains an amide segment, the number of the amide segments (average number) per molecule of the polyoxyalkylene polymer (E) may be from 1 to 10, from 1.5 to 5, or from 2 to 3. If the average number is less than 1, the curability could be insufficient. If the average number is more than 10, the polyoxyalkylene polymer (E) could have a high viscosity and be difficult to handle. To reduce the viscosity of the curable composition and improve the workability of the curable composition, it is preferable for the polyoxyalkylene polymer (E) to contain no amide segment.

Methods for blending the (meth)acrylic ester polymer (A) and the polyoxyalkylene polymer (E) are proposed, for example, in Japanese Laid-Open Patent Application Publication No. S59-122541, Japanese Laid-Open Patent Application Publication No. S63-112642, Japanese Laid-Open Patent Application Publication No. H6-172631, and Japanese Laid-Open Patent Application Publication No. H11-116763. An alternative method is to polymerize a (meth)acrylic ester monomer in the presence of an oxypropylene polymer having a hydrolyzable silyl group. The details of this production method are disclosed in various publications such as Japanese Laid-Open Patent Application Publication No. S59-78223, Japanese Laid-Open Patent Application Publication No. S60-228516, and Japanese Laid-Open Patent Application Publication No. S60-228517. In one or more embodiments, the blending of the (meth)acrylic ester polymer (A) and the polyoxyalkylene polymer (E) can be accomplished by, but is not limited to using, any of the methods as described in the publications mentioned above.

In the case where the curable composition according to one or more embodiments contains the polyoxyalkylene polymer (E), the weight ratio of the (meth)acrylic ester polymer (A) to the polyoxyalkylene polymer (E) is not limited to a particular range and may be, for example, from 99:1 to 10:90. The weight ratio may be from 90:10 to 15:85, from 80:20 to 20:80, or from 70:30 to 25:75. In particular, increasing the proportion of the polyoxyalkylene polymer (E) can improve the storage stability of the curable composition and enhance the reducing effect on the increase in viscosity over time during storage.

The (meth)acrylic ester polymer (A) and the polyoxyalkylene polymer (E) may be compatible with each other. The two polymers can be made compatible with each other by appropriately selecting the types and proportions of the monomers forming the polymers. Each of the (meth)acrylic ester polymer (A) and the polyoxyalkylene polymer (E) may consist only of one polymer or may be a combination of two or more polymers.

### <<Additional Components>>

The curable composition according to one or more embodiments may contain additional components in addition to the hydrolyzable silyl group-containing (meth)acrylic ester polymer (A), the chlorinated polyolefin resin (B), the nitrogen-containing dialkoxysilane compound (C), the guanidino group-containing compound (D) which is an optional component, and the hydrolyzable silyl group-containing polyoxyalkylene polymer (E) which is an optional component. Examples of the additional components include a silanol condensation catalyst, a filler, an adhesion promoter, a plasticizer, an anti-sagging agent, an antioxidant, a light stabilizer, an ultraviolet absorber, a property modifier, a tackifying resin, a photocurable material, an oxygen-curable material, an epoxy resin, and another resin.

Furthermore, the curable composition according to one or more embodiments may, if necessary, contain various additives for the purpose of adjusting the physical properties of the curable composition or a cured product of the composition. Examples of the additives include a surface modifier, a blowing agent, a curability modifier, a flame retardant, a silicate, a radical inhibitor, a metal deactivator, an antiozonant, a phosphorus-based peroxide decomposer, a lubricant, a pigment, and a fungicide.

### <Silanol Condensation Catalyst>

The curable composition may contain a silanol condensation catalyst for the purpose of accelerating the hydrolysis and condensation reaction of the hydrolyzable silyl groups of the component (A) and the optional component (E) and increasing the chain length of the polymers or crosslinking the polymers.

Examples of the silanol condensation catalyst include an organotin compound, a metal carboxylate, an amine compound, a carboxylic acid, and an alkoxy metal.

Specific examples of the organotin compound include dibutyltin dilaurate, dibutyltin dioctanoate, dibutyltin bis(butyl maleate), dibutyltin diacetate, dibutyltin oxide, dibutyltin bis(acetylacetonate), a reaction product of dibutyltin oxide and a silicate compound, a reaction product of dibutyltin oxide and a phthalic ester, dioctyltin diacetate, dioctyltin dilaurate, dioctyltin bis(ethyl maleate), dioctyltin bis(octyl maleate), dioctyltin bis(acetylacetonate), dioctyltin distearate, dioctyltin oxide, and a reaction product of dioctyltin oxide and a silicate compound.

Specific examples of the metal carboxylate include tin carboxylate, bismuth carboxylate, titanium carboxylate, zirconium carboxylate, iron carboxylate, potassium carboxylate, and calcium carboxylate. The metal carboxylate may be a combination of any of carboxylic acids mentioned below and any of various metals.

Specific examples of the amine compound include: amines such as octylamine, 2-ethylhexylamine, laurylamine, and stearylamine; nitrogen-containing heterocyclic compounds such as pyridine, 1,8-diazabicyclo[5,4,0]undec-7-ene (DBU), and 1,5-diazabicyclo[4,3,0]non-5-ene (DBN); and ketimine compounds.

Specific examples of the carboxylic acid include acetic acid, propionic acid, butyric acid, 2-ethylhexanoic acid, lauric acid, stearic acid, oleic acid, linoleic acid, neodecanoic acid, and versatic acid.

Specific examples of the alkoxy metal include: titanium compounds such as tetrabutyl titanate, titanium tetrakis(acetylacetonate), and diisopropoxytitanium bis(ethyl acetoacetate); aluminum compounds such as aluminum tris(acetylacetonate) and diisopropoxyaluminum ethyl acetoacetate; and zirconium compounds such as zirconium tetrakis(acetylacetonate).

Examples of other silanol condensation catalysts which can be used include fluorine anion-containing compounds, photoacid generators, and photobase generators.

One silanol condensation catalyst may be used alone, or two or more silanol condensation catalysts may be used in combination. For example, the use of the above-described amine compound in combination with the above-described carboxylic acid or alkoxy metal can provide a reactivity enhancing effect.

The amount of the silanol condensation catalyst used may be from 0.001 to 20 parts by weight, from 0.01 to 15 parts by weight, or from 0.01 to 10 parts by weight per 100 parts by weight of the component (A) or, in the case where the curable composition contains the component (E), per 100 parts by weight of the total amount of the components (A) and (E). A kind of silanol condensation catalyst could, after curing of the curable composition, seep to or smear the surface of the cured product. An approach to this issue is to limit the amount of the silanol condensation catalyst to the range of 0.01 to 3.0 parts by weight. Doing so allows the cured product to maintain a good surface condition while ensuring the curability of the composition.

### <Filler>

The curable composition according to one or more embodiments may contain a filler. Examples of the filler include ground calcium carbonate, colloidal calcium carbonate, magnesium carbonate, diatomite, clay, talc, titanium oxide, fumed silica, precipitated silica, crystalline silica, molten silica, silicic anhydride, hydrated silicic acid, alumina, carbon black, ferric oxide, aluminum fines, zinc oxide, activated zinc oxide, PVC powder, PMMA powder, and glass fibers or filaments. One filler may be used alone, or two or more fillers may be used in combination.

The amount of the filler used may be from 1 to 300 parts by weight or from 10 to 250 parts by weight per 100 parts by weight of the component (A) or, in the case where the curable composition contains the component (E), per 100 parts by weight of the total amount of the components (A) and (E).

Organic or inorganic balloons may be added to reduce the weight (or reduce the specific gravity) of the composition. The “balloons” are hollow, spherical particles used as a filler, and examples of the material of the balloons include inorganic materials such as glass and Shirasu and organic materials such as phenolic resin, urea resin, polystyrene, and Saran.

The amount of the balloons used may be from 0.1 to 100 parts by weight or from 1 to 20 parts by weight per 100 parts by weight of the component (A) or, in the case where the curable composition contains the component (E), per 100 parts by weight of the total amount of the components (A) and (E).

### <Adhesion Promoter>

An adhesion promoter other than nitrogen-containing dialkoxysilane compounds can be added to the curable composition according to one or more embodiments. A silane coupling agent or a reaction product of the silane coupling agent can be added as the adhesion promoter.

Specific examples of the silane coupling agent include: amino group-containing silanes other than nitrogen-containing dialkoxysilane compounds, such as γ-aminopropyltrimethoxysilane, N-β-aminoethyl-γ-aminopropyltrimethoxysilane, N-phenyl-γ-aminopropyltrimethoxysilane, and (2-aminoethyl)aminomethyltrimethoxysilane; isocyanate group-containing silanes such as γ-isocyanatopropyltrimethoxysilane, γ-isocyanatopropyltriethoxysilane, γ-isocyanatopropylmethyldimethoxysilane, α-isocyanatomethyltrimethoxysilane, and α-isocyanatomethyldimethoxymethylsilane; mercapto group-containing silanes such as γ-mercaptopropyltrimethoxysilane, γ-mercaptopropyltriethoxysilane, and γ-mercaptopropylmethyldimethoxysilane; and epoxy group-containing silanes such as γ-glycidoxypropyltrimethoxysilane and β-(3,4-epoxycyclohexyl)ethyltrimethoxysilane. Condensation products of various silane coupling agents can also be used such as a condensation product of an amino group-containing silane and a condensation product of an amino group-containing silane and another alkoxysilane. Reaction products of various silane coupling agents can also be used such as a reaction product of an amino group-containing silane and an epoxy group-containing silane and a reaction product of an amino group-containing silane and a (meth)acrylic group-containing silane. One adhesion promoter may be used alone, or two or more adhesion promoters may be used in combination.

The amount of the adhesion promoter used may be from 0.1 to 20 parts by weight or from 0.5 to 10 parts by weight per 100 parts by weight of the component (A) or, in the case where the curable composition contains the component (E), per 100 parts by weight of the total amount of the components (A) and (E).

### <Plasticizer>

A plasticizer can be added to the curable composition according to one or more embodiments. Specific examples of the plasticizer include: phthalic ester compounds such as dibutyl phthalate, diisononyl phthalate (DINP), diheptyl phthalate, di(2-ethylhexyl) phthalate, diisodecyl phthalate (DIDP), and butyl benzyl phthalate; terephthalic ester compounds such as bis(2-ethylhexyl)-1,4-benzenedicarboxylate; non-phthalic ester compounds such as diisononyl 1,2-cyclohexanedicarboxylate; aliphatic polycarboxylic ester compounds such as dioctyl adipate, dioctyl sebacate, dibutyl sebacate, diisodecyl succinate, and tributyl acetylcitrate; unsaturated fatty acid ester compounds such as butyl oleate and methyl acetyl ricinoleate; alkylsulfonic acid phenyl esters; phosphoric ester compounds; trimellitic ester compounds; chlorinated paraffin; hydrocarbon oils such as alkyl diphenyl and partially-hydrogenated terphenyl; process oil; and epoxy plasticizers such as epoxidized soybean oil, benzyl epoxystearate, bis(2-ethylhexyl)-4,5-epoxycyclohexane-1,2-dicarboxylate (E-PS), epoxy octyl stearate, and epoxy butyl stearate.

A polymeric plasticizer can also be used. Specific examples of the polymeric plasticizer include: vinyl polymers; polyester plasticizers; polyethers such as polyether polyols (e.g., polyethylene glycol and polypropylene glycol having a number-average molecular weight of 500 or more) and derivatives resulting from conversion of the hydroxy groups of the polyether polyols to other groups such as ester or ether groups; polystyrenes; polybutadiene; polybutene; polyisobutylene; butadiene-acrylonitrile; and polychloroprene. One plasticizer may be used alone, or two or more plasticizers may be used in combination.

The amount of the plasticizer used may be from 5 to 150 parts by weight, from 10 to 120 parts by weight, or from 20 to 100 parts by weight per 100 parts by weight of the component (A) or, in the case where the curable composition contains the component (E), per 100 parts by weight of the total amount of the components (A) and (E).

### <Anti-Sagging Agent>

An anti-sagging agent may be added to the curable composition according to one or more embodiments to prevent sagging and improve workability. Examples of the anti-sagging agent include, but are not limited to, polyamide waxes, hydrogenated castor oil derivatives, and metallic soaps such as calcium stearate, aluminum stearate, and barium stearate. One of these anti-sagging agents may be used alone, or two or more thereof may be used in combination.

The amount of the anti-sagging agent used may be from 0.1 to 20 parts by weight per 100 parts by weight of the component (A) or, in the case where the curable composition contains the component (E), per 100 parts by weight of the total amount of the components (A) and (E).

### <Antioxidant>

An antioxidant (anti-aging agent) may be added to the curable composition according to one or more embodiments. The use of an antioxidant can increase the weathering resistance of the cured product. Examples of the antioxidant include hindered phenol antioxidants, monophenol antioxidants, bisphenol antioxidants, and polyphenol antioxidants. Specific examples of the antioxidant are described in Japanese Laid-Open Patent Application Publication No. H4-283259 and Japanese Laid-Open Patent Application Publication No. H9-194731.

The amount of the antioxidant used may be from 0.1 to 10 parts by weight or from 0.2 to 5 parts by weight per 100 parts by weight of the component (A) or, in the case where the curable composition contains the component (E), per 100 parts by weight of the total amount of the components (A) and (E).

### <Light Stabilizer>

A light stabilizer may be added to the curable composition according to one or more embodiments. The use of a light stabilizer can prevent photooxidative degradation of the cured product. Examples of the light stabilizer include benzotriazole, hindered amine, and benzoate compounds. Particularly preferred are hindered amine compounds.

The amount of the light stabilizer used may be from 0.1 to 10 parts by weight or from 0.2 to 5 parts by weight per 100 parts by weight of the component (A) or, in the case where the curable composition contains the component (E), per 100 parts by weight of the total amount of the components (A) and (E).

### <Ultraviolet Absorber>

An ultraviolet absorber may be added to the curable composition according to one or more embodiments. The use of an ultraviolet absorber can increase the surface weathering resistance of the cured product. Examples of the ultraviolet absorber include benzophenone, benzotriazole, salicylate, substituted acrylonitrile, and metal chelate compounds. Particularly preferred are benzotriazole compounds, examples of which include those sold under the trade names Tinuvin P, Tinuvin 213, Tinuvin 234, Tinuvin 326, Tinuvin 327, Tinuvin 328, Tinuvin 329, and Tinuvin 571 (all of these are manufactured by BASF).

The amount of the ultraviolet absorber used may be from 0.1 to 10 parts by weight or from 0.2 to 5 parts by weight per 100 parts by weight of the component (A) or, in the case where the curable composition contains the component (E), per 100 parts by weight of the total amount of the components (A) and (E).

### <Property Modifier>

A property modifier may be added to the curable composition according to one or more embodiments in order to adjust the tensile properties of the cured product. Examples of the property modifier include, but are not limited to: alkylalkoxysilanes such as phenoxytrimethylsilane, methyltrimethoxysilane, dimethyldimethoxysilane, trimethylmethoxysilane, and n-propyltrimethoxysilane; arylalkoxysilanes such as diphenyldimethoxysilane and phenyltrimethoxysilane; alkylisopropenoxysilanes such as dimethyldiisopropenoxysilane, methyltriisopropenoxysilane, and γ-glycidoxypropylmethyldiisopropenoxysilane; trialkylsilyl borates such as tris(trimethylsilyl) borate and tris(triethylsilyl) borate; silicone varnishes; and polysiloxanes. The use of the property modifier can increase the hardness of the cured product of the curable composition according to one or more embodiments or conversely decrease the hardness and increase the elongation at break of the cured product. One property modifier as described above may be used alone, or two or more such property modifiers may be used in combination.

In particular, a compound hydrolyzable to form a compound having a monovalent silanol group in the molecule has the advantage of decreasing the modulus of the cured product without aggravating the stickiness of the surface of the cured product. Particularly preferred is a compound the hydrolysis of which gives trimethylsilanol. Examples of the compound hydrolyzable to form a compound having a monovalent silanol group in the molecule include silicon compounds which are derivatives of alcohols such as hexanol, octanol, phenol, trimethylolpropane, glycerin, pentaerythritol, and sorbitol and the hydrolysis of which gives monosilanols. Specific examples include phenoxytrimethylsilane and tris((trimethylsiloxy)methyl)propane.

The amount of the property modifier used may be from 0.1 to 10 parts by weight or from 0.5 to 5 parts by weight per 100 parts by weight of the component (A) or, in the case where the curable composition contains the component (E), per 100 parts by weight of the total amount of the components (A) and (E).

### <Tackifying Resin>

A tackifying resin can be added, if necessary, to the curable composition according to one or more embodiments for the purpose of increasing the adhesion to a substrate, ensuring close contact with the substrate, or any other purpose. Specific examples of the tackifying resin include terpene resins, aromatic modified terpene resins, hydrogenated terpene resins, terpene-phenol resins, phenol resins, modified phenol resins, xylene-phenol resins, cyclopentadiene-phenol resins, coumarone-indene resins, rosin resins, rosin ester resins, hydrogenated rosin ester resins, xylene resins, low-molecular-weight polystyrene resins, styrene copolymer resins, styrene block copolymers, hydrogenated styrene block copolymers, petroleum resins (such as C5 hydrocarbon resins, C9 hydrocarbon resins, and C5-C9 hydrocarbon copolymer resins), hydrogenated petroleum resins, and DCPD resins. One of these may be used alone, or two or more thereof may be used in combination.

The amount of the tackifying resin used may be from 2 to 100 parts by weight, from 5 to 50 parts by weight, or from 5 to 30 parts by weight per 100 parts by weight of the component (A) or, in the case where the curable composition contains the component (E), per 100 parts by weight of the total amount of the components (A) and (E).

### <Photocurable Material>

A photocurable material may be added to the curable composition according to one or more embodiments. The use of a photocurable material can lead to the formation of a coating of the photocurable material on the surface of the cured product, resulting in a reduction in stickiness of the cured product or an increase in weathering resistance of the cured product. A wide variety of such compounds are known, including organic monomers, oligomers, resins, and compositions containing them. Typical examples of photocurable materials which can be used include: an unsaturated acrylic compound which is a monomer or an oligomer having one to several unsaturated acrylic or methacrylic groups or a mixture of the monomer and oligomer; polyvinyl cinnamates; and azide resins.

The amount of the photocurable material used may be from 0.1 to 20 parts by weight or from 0.5 to 10 parts by weight per 100 parts by weight of the component (A) or, in the case where the curable composition contains the component (E), per 100 parts by weight of the total amount of the components (A) and (E).

### <Oxygen-Curable Material>

An oxygen-curable material may be added to the curable composition according to one or more embodiments. Examples of the oxygen-curable material include unsaturated compounds reactive with oxygen in the air. The oxygen-curable material reacts with oxygen in the air to form a cured coating in the vicinity of the surface of the cured product, thus offering benefits such as preventing the surface of the cured product from being sticky and preventing deposition of dirt and dust on the surface of the cured product. Specific examples of the oxygen-curable material include: drying oils exemplified by tung oil and linseed oil; various alkyd resins resulting from modification of the drying oil compounds; drying oil-modified acrylic polymers, epoxy resins, and silicone resins; and liquid polymers such as 1,2-polybutadiene, 1,4-polybutadiene, and C5 to C8 diene polymers which are obtained by polymerization or copolymerization of diene compounds such as butadiene, chloroprene, isoprene, and 1,3-pentadiene. One of these may be used alone, or two or more thereof may be used in combination.

The amount of the oxygen-curable material used may be from 0.1 to 20 parts by weight or from 0.5 to 10 parts by weight per 100 parts by weight of the component (A) or, in the case where the curable composition contains the component (E), per 100 parts by weight of the total amount of the components (A) and (E). As taught in Japanese Laid-Open Patent Application Publication No. H3-160053, the oxygen-curable material can be used in combination with a photocurable material.

### <Epoxy Resin>

An epoxy resin may be added to the curable composition according to one or more embodiments. The composition containing an added epoxy resin is particularly suitable for use as an adhesive for exterior wall tiles. Examples of the epoxy resin include bisphenol A epoxy resins and novolac epoxy resins.

As for the ratio between the epoxy resin used and the component (A) or (E), the weight ratio of the component (A) or the total of the components (A) and (E) to the epoxy resin may be from 100/1 to 1/100. When the ratio of the component (A) or the total of the components (A) and (E) to the epoxy resin is 1/100 or more, the improving effect on the impact resistance and toughness of a cured product of the epoxy resin is likely to be obtained. When the ratio of the component (A) or the total of the components (A) and (E) to the epoxy resin is 100/1 or less, a cured product of the composition can have high strength.

In the case where the epoxy resin is added to the curable composition according to one or more embodiments, a curing agent for curing the epoxy resin can also be used in the composition. The epoxy resin-curing agent used is not limited to a particular type and may be a commonly used epoxy resin-curing agent.

In the case where a curing agent for curing the epoxy resin is used, the amount of the curing agent may be from 0.1 to 300 parts by weight per 100 parts by weight of the epoxy resin.

### <<Preparation of Curable Composition>>

The curable composition according to one or more embodiments can be prepared as a one-part composition all the components of which are blended together and hermetically stored and which, when applied to any object, cures under the action of moisture in the air. The curable composition can be prepared also as a two-part composition consisting of a base material containing the polymer (A) and a curing agent material which contains a silanol condensation catalyst, a filler, a plasticizer, water etc. and which is prepared separately from the base material. In the case of this two-part composition, the two materials are mixed before use. In terms of workability, the curable composition may be a one-part composition.

In the case where the curable composition is a one-part composition, all the components are blended together beforehand. Thus, it is preferable that a water-containing component be dried to remove water before use or dehydrated by means such as pressure reduction during blending or kneading. The storage stability of the composition can be further improved by not only performing the drying/dehydration process but also adding a dehydrating agent, in particular an alkoxysilane compound such as methyltrimethoxysilane, phenyltrimethoxysilane, n-propyltrimethoxysilane, vinyltrimethoxysilane, vinylmethyldimethoxysilane, γ-mercaptopropylmethyldimethoxysilane, γ-mercaptopropylmethyldiethoxysilane, or γ-glycidoxypropyltrimethoxysilane.

In the case of using a dehydrating agent, in particular a water-reactive silicon compound such as vinyltrimethoxysilane, the amount of the compound used as the dehydrating agent may be from 0.1 to 20 parts by weight or from 0.5 to 10 parts by weight per 100 parts by weight of the component (A) or, in the case where the curable composition contains the component (E), per 100 parts by weight of the total amount of the components (A) and (E).

### <<Uses>>

The curable composition according to one or more embodiments can be suitably used as an adhesive for polyolefinic materials in order to bond an adherend made of a polyolefinic material to another adherend. The curable composition according to one or more embodiments can be used to bond adherends made of a polyolefinic material to each other and can be used also to bond an adherend made of a polyolefinic material to another adherend made of a different material.

Examples of polyolefinic materials include, but are not limited to, polyethylene, polypropylene, TPO (thermoplastic olefin resin), EPDM (ethylene/propylene rubber), and polyvinyl chloride. Adherends made of such a polyolefinic material may contain various additives in addition to the polyolefin resin.

Adherends made of a polyolefinic material may be subjected to any kind of surface treatment. Examples of the surface treatment include: physical treatments such as flame treatment, corona treatment, and plasma treatment; and chemical treatments such as application of an adhesion promoter and application of a surfactant.

Examples of materials other than polyolefinic materials include wood, metals, organic materials other than polyolefins (such as a substrate made of a polyester resin such as PET or PBT, a polycarbonate substrate, and polystyrene), fiber-reinforced resins, glass, and ceramics.

Adherends are not limited to having a particular form and may be films or sheets or may be molded articles of a given shape.

Bonding of adherends to each other by means of the curable composition according to one or more embodiments is not limited to using a particular method. For example, the components of the curable composition are mixed, the mixture is applied to one of the adherends, and then the other adherend is attached to the one adherend. This is followed by aging at normal temperature or under heating for 1 to 7 days to cure the curable composition into an adhesive layer. In this way, a laminate structure can be obtained which includes the two adherends joined together via the adhesive layer.

In the following items, preferred aspects of the present disclosure are listed. One or more embodiments of the present invention are not limited to the following items.

[Item 1]

A curable composition containing:
(A) a hydrolyzable silyl group-containing (meth)acrylic ester polymer having a hydrolyzable silyl group;
(B) a chlorinated polyolefin resin; and
(C) a nitrogen-containing dialkoxysilane compound.

[Item 2]

The curable composition according to item 1, wherein the hydrolyzable silyl group is represented by the following formula (1):

—Si(R¹)₃₋ₐ(X)ₐ (1), wherein
R¹ groups are each independently a hydrocarbon group having 1 to 20 carbon atoms, the hydrocarbon group optionally has a heteroatom-containing group, X groups are each independently a hydroxy group or a hydrolyzable group, and a is 1, 2, or 3.

[Item 3]

The curable composition according to item 1 or 2, wherein the chlorinated polyolefin resin (B) is a modified chlorinated polyolefin resin.

[Item 4]

The curable composition according to any one of items 1 to 3, further containing (D) a guanidino group-containing compound having a guanidino group.

[Item 5]

The curable composition according to item 4, wherein the guanidino group-containing compound (D) is 1-(o-tolyl) biguanide.

[Item 6]

The curable composition according to any one of items 1 to 5, further containing a hydrolyzable silyl group-containing polyoxyalkylene polymer (E) having a hydrolyzable silyl group.

[Item 7]

The curable composition according to any one of claims 1 to 6, wherein an amount of the chlorinated polyolefin resin (B) is from 1 to 60 parts by weight and an amount of the nitrogen-containing dialkoxysilane compound (C) is from 0.1 to 20 parts by weight per 100 parts by weight of the hydrolyzable silyl group-containing (meth)acrylic ester polymer (A) or, in a case where the curable composition contains a hydrolyzable silyl group-containing polyoxyalkylene polymer (E) having a hydrolyzable silyl group, per 100 parts by weight of a total amount of the components (A) and (E).

[Item 8]

The curable composition according to any one of items 1 to 7, being a composition for use as an adhesive for polyolefinic materials.

[Item 9]

A cured product of the curable composition according to any one of items 1 to 8.

[Item 10]

A laminate structure including two adherends joined to each other by an adhesive layer formed by curing of the curable composition according to any one of items 1 to 8, wherein at least one of the two adherends is formed from a polyolefinic material.

### EXAMPLES

Hereinafter, one or more embodiments of the present invention will be described in more detail using specific examples. One or more embodiments of the present invention are not limited to the examples presented below.

The number-average molecular weights in the examples are GPC molecular weights measured under the following conditions.
Delivery system: HLC-8420 GPC manufactured by Tosoh Corporation
Column: TSKgel SuperH series manufactured by Tosoh Corporation
Solvent: THF
Molecular weight: Polystyrene equivalent
Measurement temperature: 40° C.

The end group-equivalent molecular weights in the examples are molecular weights each of which was measured as follows: hydroxy and iodine values were measured, respectively, by the measurement method as specified in JIS K 1557 and the measurement method as specified in JIS K 0070, and the molecular weight was calculated based on the hydroxy and iodine values taking into account the architecture of the organic polymer (the degree of branching which depends on the polymerization initiator used).

The average number of silyl groups per polymer end or polymer molecule in each of the examples was determined by H-NMR analysis (performed in a CDCl₃ solvent using JNM-LA400 manufactured by JEOL Ltd.).

### Synthesis Example 1

Butyl acrylate (62.7 parts by weight), ethyl acrylate (18.3 parts by weight), and stearyl acrylate (19.0 parts by weight) were polymerized in an acetonitrile solvent at about 80 to 90° C. using diethyl 2,5-dibromoadipate (1.64 parts by weight) as an initiator, cuprous bromide (0.79 parts by weight) as a catalyst, and pentamethyldiethylenetriamine as a catalyst ligand. This polymerization yielded a polyacrylic ester terminated at both ends by bromine groups. The polymerization reaction rate was controlled by adjusting the amount of pentamethyldiethylenetriamine as appropriate. Subsequently, the terminal bromine groups of the polymer were reacted with 1,7-octadiene in an acetonitrile solvent using a pentamethyldiethylenetriamine complex of cuprous bromide as a catalyst to obtain a polyacrylic ester. The amount of 1,7-octadiene was 40 molar equivalents per molar equivalent of the initiator. After the reaction, 1,7-octadiene remaining unreacted was removed by evaporation. The resulting polymer was purified by adsorption, and the purified polymer was heated to about 190° C. and subjected to a debromination reaction, which was followed by further purification by adsorption to obtain a polyacrylic ester terminated at both ends by alkenyl groups.

To the obtained polyacrylic ester terminated at both ends by alkenyl groups was added 300 ppm of an isopropanol solution containing a platinum-vinylsiloxane complex as a catalyst and having a platinum content of 3 wt %, and methyldimethoxysilane was reacted with the alkenyl groups of the polyacrylic ester at 100° C. for 1 hour. The reaction was carried out in the presence of methyl orthoformate, and the amount of methyldimethoxysilane was 3.3 molar equivalents per molar equivalent of the alkenyl groups. After the reaction, methyldimethoxysilane and methyl orthoformate remaining unreacted were removed by evaporation to obtain a methyldimethoxysilyl-terminated polyacrylic ester (A-1). The obtained polymer had a number-average molecular weight of 26,000 and a dispersity of 1.3, and the number of silyl groups introduced per molecule was 2.0.

### Synthesis Example 2

Butyl acrylate (69.9 parts by weight), ethyl acrylate (10.6 parts by weight), and stearyl acrylate (18.6 parts by weight) were polymerized in an acetonitrile solvent at about 80 to 90° C. using diethyl 2,5-dibromoadipate (1.06 parts by weight) as an initiator, cuprous bromide (0.76 parts by weight) as a catalyst, and pentamethyldiethylenetriamine as a catalyst ligand. This polymerization yielded a polyacrylic ester terminated at both ends by bromine groups. The polymerization reaction rate was controlled by adjusting the amount of pentamethyldiethylenetriamine as appropriate. Subsequently, the terminal bromine groups of the polymer were reacted with 1,7-octadiene in an acetonitrile solvent using a pentamethyldiethylenetriamine complex of cuprous bromide as a catalyst to obtain a polyacrylic ester. The amount of 1,7-octadiene was 60 molar equivalents per molar equivalent of the initiator. After the reaction, 1,7-octadiene remaining unreacted was removed by evaporation. The resulting polymer was purified by adsorption, and the purified polymer was heated to about 190° C. and subjected to a debromination reaction, which was followed by further purification by adsorption to obtain a polyacrylic ester terminated at both ends by alkenyl groups.

To the obtained polyacrylic ester terminated at both ends by alkenyl groups was added 300 ppm of an isopropanol solution containing a platinum-vinylsiloxane complex as a catalyst and having a platinum content of 3 wt %, and methyldimethoxysilane was reacted with the alkenyl groups of the polyacrylic ester at 100° C. for 1 hour. The reaction was carried out in the presence of methyl orthoformate, and the amount of methyldimethoxysilane was 4 molar equivalents per molar equivalent of the alkenyl groups. After the reaction, methyldimethoxysilane and methyl orthoformate remaining unreacted were removed by evaporation to obtain a methyldimethoxysilyl-terminated polyacrylic ester (A-2). The obtained polymer had a number-average molecular weight of 40,500 and a dispersity of 1.3, and the number of silyl groups introduced per molecule was 2.0.

### Synthesis Example 3

Propylene oxide was polymerized using polyoxypropylene glycol having a number-average molecular weight of about 2,500 as an initiator in the presence of a zinc hexacyanocobaltate-glyme complex catalyst to obtain polyoxypropylene (P-1) terminated at both ends by hydroxy groups and having a number-average molecular weight of 25,000 (end group-equivalent molecular weight=16,500) and a dispersity Mw/Mn of 1.25.

Subsequently, 1.2 molar equivalents of sodium methoxide dissolved in methanol at a concentration of 28% was added per molar equivalent of the hydroxy groups of the hydroxy-terminated polyoxypropylene (P-1). Methanol was distilled off by evaporation under vacuum, and then 1.5 molar equivalents of allyl chloride was added per molar equivalent of the hydroxy groups of the polymer to convert the terminal hydroxy groups to allyl groups. Allyl chloride remaining unreacted was removed by evaporation under reduced pressure. The resulting unpurified polyoxypropylene, n-hexane, and water were mixed and stirred, and the mixture was then centrifuged to remove water. Hexane was evaporated from the resulting hexane solution under reduced pressure, and thus the metal salt was removed from the polymer. In this manner, polyoxypropylene (Q-1) terminated by an allyl group was obtained.

To the polymer (Q-1) was added 36 ppm of a platinum-divinyldisiloxane complex solution (2-propanol solution with a concentration of 3 wt % calculated as the platinum content), and 0.9 parts by weight of dimethoxymethylsilane was slowly added dropwise under stirring. The resulting mixture was reacted at 90° C. for 2 hours, after which dimethoxymethylsilane remaining unreacted was distilled off under reduced pressure to obtain polyoxypropylene (E-1) terminated by a dimethoxymethylsilyl group and having a number-average molecular weight of about 25,500. The polymer (E-1) was found to have 0.7 dimethoxymethylsilyl groups on average per end and 1.4 dimethoxymethylsilyl groups on average per molecule.

### Synthesis Example 4

A four-necked flask equipped with a stirrer was charged with 52.1 parts by weight of isobutyl alcohol, which was heated to 90° C. under nitrogen atmosphere. To the heated isobutyl alcohol was added dropwise over 7 hours a liquid mixture prepared by dissolving 14.5 parts by weight of methyl methacrylate, 68.2 parts by weight of butyl acrylate, 14.9 parts by weight of stearyl methacrylate, 2.4 parts by weight of 3-(dimethoxymethylsilyl) propyl methacrylate, and 0.3 parts by weight of 2,2′-azobis(2-methylbutyronitrile) in 12.4 parts by weight of isobutyl alcohol. The polymerization was allowed to proceed at 90° C. for another 2 hours to obtain an isobutyl alcohol solution (solid content=60 wt %) of a poly(meth)acrylic ester (A-3) having 1.8 methyldimethoxysilyl groups on average per molecule and having a number-average molecular weight of 17,000 and a weight-average molecular weight of 48,000.

### Synthesis Example 5

An amount of 70 parts by weight of the polyoxypropylene (E-1) obtained in Synthesis Example 3 and 50 parts by weight of the isobutyl alcohol solution of the poly(meth)acrylic ester (A-3) obtained in Synthesis Example 4 were mixed, and isobutyl alcohol was distilled off under reduced pressure to obtain a polymer mixture having a polyoxypropylene (E-1)/poly(meth)acrylic ester (A-3) weight ratio of 70/30.

### Synthesis Example 6

Propylene oxide was polymerized using polyoxypropylene diol having a molecular weight of about 2,500 as an initiator in the presence of a zinc hexacyanocobaltate-glyme complex catalyst to obtain polypropylene oxide having a number-average molecular weight of about 16,000. Subsequently, 1.2 molar equivalents of NaOMe dissolved in methanol was added per molar equivalent of the hydroxy groups of the hydroxy-terminated polypropylene oxide obtained as above, and then methanol was distilled off. Allyl chloride was further added to convert the terminal hydroxy groups to allyl groups. In this manner, allyl-terminated polypropylene oxide having a number-average molecular weight of about 16,000 was obtained.

To 100 parts by weight of the unpurified allyl-terminated polypropylene oxide obtained as above were added 300 parts by weight of n-hexane and 300 parts by weight of water, and the mixture was stirred and then centrifuged to remove water. To the resulting hexane solution was added 300 parts by weight of water, and the mixture was stirred and centrifuged to remove water. After that, hexane was removed by evaporation under reduced pressure to obtain purified allyl-terminated polypropylene oxide (hereinafter referred to as “allyl polymer”). To 100 parts by weight of the obtained allyl polymer was added 150 ppm of an isopropanol solution containing a platinum-vinylsiloxane complex as a catalyst and having a platinum content of 3 wt %, and methyldimethoxysilane was added in an amount of 0.6 molar equivalents per molar equivalent of the allyl groups of the allyl polymer and reacted with the allyl groups at 90° C. for 2 hours to obtain methyldimethoxysilyl-terminated polypropylene oxide (E-2). The polymer (E-2) was found to have 0.6 methyldimethoxysilyl groups on average per end and 1.2 methyldimethoxysilyl groups on average per molecule.

### Example 1

The polyacrylic ester (A-1), ground calcium carbonate (manufactured by Shiraishi Calcium Kaisha, Ltd., trade name: “Whiton SB”), a plasticizer (DINP, diisononyl phthalate), and an antioxidant (manufactured by BASF Japan Co., Ltd., trade name: “Irganox 245”) were weighed out according to the proportions shown in Table 1 and were mixed by means of a spatula. The mixture was then passed through a three-roll mill three times to disperse the components of the mixture. After that, the mixture was dried using a planetary mixer under reduced pressure at 120° C. for 2 hours. The mixture was cooled to 50° C. or below, and then a chlorinated polyolefin resin (B) (manufactured by Advanced Polymer Inc., trade name: AdvaBond 8203, maleic anhydride-modified chlorinated polyolefin resin), a dehydrating agent (manufactured by Momentive, trade name: Silquest A171, vinyltrimethoxysilane), (N-(2-aminoethyl)-3-aminopropylmethyldimethoxysilane as a nitrogen-containing dialkoxysilane compound (C) serving the function of an adhesion promoter (manufactured by Shin-Etsu Chemical Co., Ltd., trade name: KBM-602), and 1-(o-tolyl) biguanide as a guanidino group-containing compound (D) (manufactured by Tokyo Chemical Industry Co., Ltd.) were added to and mixed with the cooled mixture. The resulting mixture was further mixed with U-220H (manufactured by Nitto Kasei Co., Ltd.) added as a curing catalyst, and thus a curable composition was obtained. The obtained curable composition was placed into a moisture-proof cartridge, which was hermetically sealed to obtain a one-part curable composition (Blend 1).

### Example 2

A curable composition (Blend 2) was obtained in the same manner as Blend 1, except that surface-treated ground calcium carbonate (manufactured by Shanghai Xiefeng Industry Development Co., Ltd., trade name: XL-8500C) was used instead of ground calcium carbonate (manufactured by Shiraishi Calcium Kaisha, Ltd.).

### Example 3

A curable composition (Blend 3) was obtained in the same manner as Blend 1, except that the polyacrylic ester (A-2) was used instead of the polyacrylic ester (A-1).

### Example 4

A curable composition (Blend 4) was obtained in the same manner as Blend 1, except that the polymer mixture of the polyoxypropylene (E-1) and the poly(meth)acrylic ester (A-3) was used instead of the polyacrylic ester (A-1).

### Comparative Example 1

A curable composition (Blend 5) was obtained in the same manner as Blend 1, except that KBM-603 (manufactured by Shin-Etsu Chemical Co., Ltd., N-(2-aminoethyl)-3-aminopropyltrimethoxysilane) was used as an adhesion promoter instead of KBM-602.

### Comparative Example 2

A curable composition (Blend 6) was obtained in the same manner as Blend 1, except that the chlorinated polyolefin resin (B) (manufactured by Advanced Polymer Inc., trade name: AdvaBond 8203) was not used.

### Comparative Example 3

A curable composition (Blend 7) was obtained in the same manner as Blend 1, except that the polypropylene oxide (E-2) was used instead of the polyacrylic ester (A-1).

### (Hand Peel Adhesion)

The blends listed in Table 1, each of which was placed in the cartridge, were left at 23° C. and 50% RH for 7 days. After that, each blend was extruded as a bead onto a polypropylene (PP) substrate (manufactured by TP Giken Co., Ltd.) or an olefinic thermoplastic elastomer (TPO) substrate (manufactured by Oriental Yuhong), and the extruded blend was gently pressed by means of a microspatula and brought into close contact with the substrate. The blend was then cured at 23° C. and 50% RH for 7 days, after which a cut was made in the interface between the cured product and the substrate by means of a razor blade and the cured product was pulled with fingers in a direction at 90° to the substrate to examine hand peel adhesion. The hand peel adhesion was evaluated by visually inspecting the failure surface after the tensile test and determining whether the failure was cohesive failure (CF) or adhesive failure (AF). The results are shown in Table 1.

TABLE 1

| | | | Ex. 1 | Ex. 2 | Ex. 3 | Ex. 4 | Comp. 1 | Comp. 2 | Comp. 3 |
|---|---|---|---|---|---|---|---|---|---|
| | | | Blend 1 | Blend 2 | Blend 3 | Blend 4 | Blend 5 | Blend 6 | Blend 7 |
| (Meth)acrylic ester polymer (A) | | (A-1) | 100 | 100 | | | 100 | 100 | |
| | | (A-2) | | | 100 | | | | |
| | | (A-3) | | | | 30 | | | |
| Polyoxyalkylene polymer (E) | | (E-1) | | | | 70 | | | |
| | | (E-2) | | | | | | | 100 |
| Ground calcium carbonate | | Whiton SB | 280 | | 280 | 280 | 280 | 280 | 280 |
| Surface-treated ground | | XL-8500C | | 280 | | | | | |
| calcium carbonate | | | | | | | | | |
| Plasticizer | | DINP | 90 | 90 | 90 | 90 | 90 | 90 | 90 |
| Antioxidant | | Irganox 245 | 2 | 2 | 2 | 2 | 2 | 2 | 2 |
| Chlorinated polyolefin resin (B) | | AdvaBond 8203 | 28 | 28 | 28 | 28 | 28 | | 28 |
| Dehydrating agent | | A171 | 4 | 4 | 4 | 4 | 4 | 4 | 4 |
| Adhesion | Nitrogen-containing | KBM-602 | 5 | 5 | 5 | 5 | | 5 | 5 |
| promoter | dialkoxysilane | | | | | | | | |
| | compound (C) | | | | | | | | |
| | Nitrogen-containing | KBM-603 | | | | | 5 | | |
| | trialkoxysilane | | | | | | | | |
| | compound | | | | | | | | |

| Guanidino group-containing | 1-(o-Tolyl)biguanide | 5 | 5 | 5 | 5 | 5 | 5 | 5 |
|---|---|---|---|---|---|---|---|---|
| compound (D) | | | | | | | | |
| Curing catalyst | U-220H | 2 | 2 | 2 | 2 | 2 | 2 | 2 |
| Hand peel adhesion | PP substrate | CF | CF | CF | CF | AF | AF | AF |
| | TPO substrate | CF | CF | CF | CF | AF | AF | AF |

As seen from Table 1, the curable compositions of Examples 1 to 4, which contained the hydrolyzable silyl group-containing (meth)acrylic ester polymer (A), the chlorinated polyolefin resin (B), and the nitrogen-containing dialkoxysilane compound (C), exhibited satisfactory hand peel adhesion to the polyolefinic materials.

In Comparative Example 1, the curable composition did not contain the nitrogen-containing dialkoxysilane compound (C) but instead contained a nitrogen-containing trialkoxysilane compound. In Comparative Example 2, the curable composition did not contain the chlorinated polyolefin resin (B). In Comparative Example 3, the curable composition did not contain the hydrolyzable silyl group-containing (meth)acrylic ester polymer (A) but contained only the hydrolyzable silyl group-containing polyoxyalkylene polymer (E). In these Comparative Examples, the hand peel adhesion was insufficient.

### Example 5

A curable composition (Blend 8) was obtained in the same manner as Blend 2, except that 1-(o-tolyl) biguanide as the guanidino group-containing compound (D) (manufactured by Tokyo Chemical Industry Co., Ltd.) was not used.

### (Percentage Increase of Viscosity)

Blend 2 or 8 placed in the cartridge was left at 23° C. and 50% RH for 1 day, after which the blend was placed into a 100-cc disposable cup at 23° C. and 50% RH while avoiding bubble formation in the blend. The viscosity of the blend in the disposable cup was measured as an initial viscosity by using Model BS viscometer (manufactured by Tokyo Keiki Inc.) with rotor No. 5 at a rotational speed of 2 rpm (the viscosity value was read after three rotations). In addition, Blend 2 or 8 placed in the cartridge was stored at 50° C. for 7 days and then left at 23° C. and 50% RH for 1 day, after which the viscosity of the blend was measured as a post-storage viscosity. The percentage increase of viscosity was calculated as post-storage viscosity/initial viscosity×100%. The results are shown in Table 2.

### (Hand Peel Adhesion)

Blend 2 or 8 placed in the cartridge was left at 23° C. and 50% RH for 1 day. After that, the blend was extruded as a bead onto a polypropylene (PP) substrate (manufactured by TP Giken Co., Ltd.) or an olefinic thermoplastic elastomer (TPO) substrate (manufactured by Oriental Yuhong), and the extruded blend was gently pressed by means of a microspatula and brought into close contact with the substrate. The blend was then cured at 23° C. and 50% RH for 7 days, after which a cut was made in the interface between the cured product and the substrate by means of a razor blade and the cured product was pulled with fingers in a direction at 90° to the substrate to examine hand peel adhesion. The hand peel adhesion was evaluated by visually inspecting the failure surface after the tensile test and determining whether the failure was cohesive failure (CF) or adhesive failure (AF). The results are shown in Table 2.

TABLE 2

| | | Ex. 2 | Ex. 5 |
|---|---|---|---|
| | | Blend 2 | Blend 8 |
| (Meth)acrylic ester | (A-1) | 100 | 100 |
| polymer (A) | | | |
| Surface-treated ground | XL-8500C | 280 | 280 |
| calcium carbonate | | | |
| Plasticizer | DINP | 90 | 90 |
| Antioxidant | Irganox 245 | 2 | 2 |
| Chlorinated polyolefin | AdvaBond 8203 | 28 | 28 |
| resin (B) | | | |
| Dehydrating agent | A171 | 4 | 4 |
| Nitrogen-containing | KBM-602 | 5 | 5 |
| dialkoxysilane compound (C) | | | |
| Guanidino group-containing | 1-(o-Tolyl)biguanide | 5 | |
| compound (D) | | | |
| Curing catalyst | U-220H | 2 | 2 |
| Percentage increase | 50° C. for 7 days | 97% | 473% |
| of viscosity | | | |
| Hand peel adhesion | PP substrate | CF | CF |
| | TPO substrate | CF | CF |

As seen from Table 2, the hand peel adhesion was satisfactory in both Examples 2 and 5, and the curable composition of Example 2 which contained the guanidino group-containing compound (D) suffered less increase in viscosity over time and exhibited higher storage stability than the curable composition of Example 5 which did not contain the compound (D).

### Example 6

A curable composition (Blend 9) was obtained in the same manner as Blend 2, except that the components and their proportions were as shown in Table 3, namely that surface-treated ground calcium carbonate (manufactured by Shanghai Xiefeng Industry Development Co., Ltd., trade name: XL-8500C) and Hakuenka CCR (manufactured by Shiraishi Calcium Kaisha, Ltd.) were used in combination, 1-(o-tolyl) biguanide (manufactured by Tokyo Chemical Industry Co., Ltd.) was not used, and the amounts of the components were changed.

### Examples 7 and 8

Curable compositions (Blends 10 and 11) were obtained in the same manner as Blend 9, except that the components and their proportions were as shown in Table 3, namely that the polymer mixture of the polyoxypropylene (E-1) and the poly(meth)acrylic ester (A-3) was used in addition to the polyacrylic ester (A-1).

### Examples 9 to 11

Curable compositions (Blends 12 to 14) were obtained in the same manner as Blend 11, except that the components and their proportions were as shown in Table 3, namely that 1-(0-tolyl) biguanide (manufactured by Tokyo Chemical Industry Co., Ltd.) was used and the amount of the chlorinated polyolefin resin (B) was changed.

### (Percentage Increase of Viscosity)

Blends 9 to 14, each of which was placed in the cartridge, were left at 23° C. and 50% RH for 1 day, after which each blend was placed into a 100-cc disposable cup at 23° C. and 50% RH while avoiding bubble formation in the blend. The viscosity of the blend in the disposable cup was measured as an initial viscosity by using Model BS viscometer (manufactured by Tokyo Keiki Inc.) with rotor No. 5 at a rotational speed of 2 rpm (the viscosity value was read after three rotations). In addition, each blend placed in the cartridge was stored at 50° C. for 14 or 28 days and then left at 23° C. and 50% RH for 1 day, after which the viscosity of the blend was measured as a post-storage viscosity. The percentage increase of viscosity was calculated as post-storage viscosity/initial viscosity×100%. The results are shown in Table 3.

### (Hand Peel Adhesion)

Blends 9 to 14, each of which was placed in the cartridge, were left at 23° C. and 50% RH for 1 day. After that, each blend was extruded as a bead onto a polypropylene (PP) substrate (manufactured by TP Giken Co., Ltd.) or an olefinic thermoplastic elastomer (TPO) substrate (manufactured by Oriental Yuhong), and the extruded blend was gently pressed by means of a microspatula and brought into close contact with the substrate. The blend was then cured at 23° C. and 50% RH for 7 days, after which a cut was made in the interface between the cured product and the substrate by means of a razor blade and the cured product was pulled with fingers in a direction at 90° to the substrate to examine hand peel adhesion. The hand peel adhesion was evaluated by visually inspecting the failure surface after the tensile test and determining whether the failure was cohesive failure (CF) or adhesive failure (AF). The results are shown in Table 3.

TABLE 3

| | | Ex. 6 | Ex. 7 | Ex. 8 | Ex. 9 | Ex. 10 | Ex. 11 |
|---|---|---|---|---|---|---|---|
| | | Blend 9 | Blend 10 | Blend 11 | Blend 12 | Blend 13 | Blend 14 |
| (Meth)acrylic ester polymer (A) | (A-1) | 100 | 70 | 50 | 50 | 50 | 50 |
| | (A-3) | | 9 | 15 | 15 | 15 | 15 |
| Polyoxyalkylene polymer (E) | (E-1) | | 21 | 35 | 35 | 35 | 35 |
| Surface-treated ground calcium | XL-8500C | 50 | 50 | 50 | 50 | 50 | 50 |
| carbonate | | | | | | | |
| Surface-treated colloidal calcium | Hakuenka CCR | 160 | 160 | 160 | 160 | 160 | 160 |
| carbonate | | | | | | | |
| Plasticizer | DINP | 90 | 90 | 90 | 90 | 90 | 90 |
| Antioxidant | Irganox 245 | 2 | 2 | 2 | 2 | 2 | 2 |
| Chlorinated polyolefin resin (B) | AdvaBond 8203 | 20 | 20 | 20 | 20 | 10 | 5 |
| Dehydrating agent | A171 | 4 | 4 | 4 | 4 | 4 | 4 |
| Nitrogen-containing | KBM-602 | 2.5 | 2.5 | 2.5 | 2.5 | 2.5 | 2.5 |
| dialkoxysilane compound (C) | | | | | | | |
| Guanidino group-containing | 1-(o-Tolyl)biguanide | | | | 1 | 1 | 1 |
| compound (D) | | | | | | | |
| Curing catalyst | U-220H | 2 | 2 | 2 | 2 | 2 | 2 |
| Percentage increase of viscosity | 50° C. for 14 days | 210% | 154% | 136% | 97% | 93% | 95% |
| | 50° C. for 28 days | 220% | 157% | 136% | 99% | 96% | 94% |
| Hand peel adhesion | PP substrate | CF | CF | CF | CF | CF | CF |
| | TPO substrate | CF | CF | CF | CF | CF | CF |

As seen from Table 3, the hand peel adhesion was satisfactory in all of Examples 6 to 11.

The curable compositions of Examples 7 and 8, in which the polymer mixture of the polyoxypropylene (E-1) and the poly(meth)acrylic ester (A-3) was used in addition to the polyacrylic ester (A-1), suffered less increase in viscosity over time and exhibited higher storage stability than the curable composition of Example 6 in which only the polyacrylic ester (A-1) was used.

The curable composition of Example 9, which contained the guanidino group-containing compound (D), suffered less increase in viscosity over time and exhibited higher storage stability than the curable composition of Example 8 which did not contain the compound (D). Additionally, in Examples 10 and 11 in which the amount of the chlorinated polyolefin resin (B) was smaller than in Example 9, there was no reduction in the hand peel adhesion, and satisfactory storage stability was achieved.

Although the disclosure has been described with respect to only a limited number of embodiments, those skilled in the art, having benefit of this disclosure, will appreciate that various other embodiments may be devised without departing from the scope of the present disclosure. Accordingly, the scope of the disclosure should be limited only by the attached claims.

1. A curable composition comprising:
(A) a hydrolyzable silyl group-containing (meth)acrylic ester polymer having a hydrolyzable silyl group;
(B) a chlorinated polyolefin resin; and
(C) a nitrogen-containing dialkoxysilane compound,
wherein the chlorinated polyolefin resin (B) is a modified chlorinated polyolefin resin.

2. The curable composition according to claim 1, wherein the hydrolyzable silyl group is represented by the following formula (1):
—Si(R¹)₃₋ₐ(X)ₐ (1),
wherein R¹ groups are each independently a hydrocarbon group having 1 to 20 carbon atoms, the hydrocarbon group optionally has a heteroatom-containing group, X groups are each independently a hydroxy group or a hydrolyzable group, and a is 1, 2, or 3.

3. The curable composition according to claim 1, further comprising (D) a guanidino group-containing compound having a guanidino group.

4. The curable composition according to claim 3, wherein the guanidino group-containing compound (D) is 1-(o-tolyl) biguanide.

5. The curable composition according to claim 1, further comprising a hydrolyzable silyl group-containing polyoxyalkylene polymer (E) having a hydrolyzable silyl group.

6. The curable composition according to claim 1, wherein an amount of the chlorinated polyolefin resin (B) is from 1 to 60 parts by weight and an amount of the nitrogen-containing dialkoxysilane compound (C) is from 0.1 to 20 parts by weight per 100 parts by weight of the hydrolyzable silyl group-containing (meth)acrylic ester polymer (A) or, in a case where the curable composition comprises a hydrolyzable silyl group-containing polyoxyalkylene polymer (E) having a hydrolyzable group, per 100 parts by weight of a total amount of the components (A) and (E).

7. The curable composition according to claim 1, being a composition for use as an adhesive for polyolefinic materials.

8. A cured product of the curable composition according to claim 1.

9. A laminate structure comprising two adherends joined to each other by an adhesive layer formed by curing of the curable composition according to claim 1,
wherein at least one of the two adherends is formed from a polyolefinic material.

10. A curable composition comprising:
(A) a hydrolyzable silyl group-containing (meth)acrylic ester polymer having a hydrolyzable silyl group;
(B) a chlorinated polyolefin resin;
(C) a nitrogen-containing dialkoxysilane compound; and
(D) a guanidino group-containing compound having a guanidino group.

11. The curable composition according to claim 10, wherein the guanidino group-containing compound (D) is 1-(o-tolyl) biguanide.
